(19) United States
(12) Patent Application Publication
(10) Pub. No.: US 2018/0197149 A1
(43) Pub. Date: Jul. 12, 2018

(54) AUTOMATED METHODS AND SYSTEMS TO SCHEDULE ACTIVITIES

(71) Applicant: 6Crickets, Inc., Bellevue, WA (US)

(72) Inventors: Helen J. Wang, Bellevue, WA (US); Kristina Toutanova, Redmond, WA (US); Adam Costello, Bellevue, WA (US)

(73) Assignee: 6Crickets, Inc., Bellevue, WA (US)

(21) Appl. No.: 15/865,127

(22) Filed: Jan. 8, 2018

Related U.S. Application Data
(60) Provisional application No. 62/443,507, filed on Jan. 6, 2017.

(51) Int. Cl. G06Q 10/10; G06Q 10/06; G06F 3/0482

(52) U.S. Cl. CPC G06Q 10/1093; G06F 3/0482; G06Q 10/06

(57) ABSTRACT

This disclosure is directed to fully automated schedule recommendation methods and systems that generate one or more predicted schedules of activities. The activities can be events, classes, courses, camps, workshops, private lessons, tutoring sessions, or any organized activities, lessons or schedules items offered by enrichment provider. The schedule recommendation methods and systems use machine learning techniques to computationally predict activities that satisfy user constraints and aggregates predicted schedules over time to propose full schedules of predicted activities that are most appropriate for the user and satisfies the multiple user constraints. The schedule recommendation methods and systems enable the user to select individual predicted activities, register the user with the enrichment providers that offer the selected activities, and pay the enrichment providers for the selected activities when the user checks out.

### CROSS-REFERENCE TO RELATED APPLICATION

This application claims priority from Provisional Application 62/443,507, filed Jan. 6, 2017.

### BACKGROUND

In recent years, the demand for education enrichment programs has dramatically increased. This strong demand has encouraged an increase in quantity, quality, and variety of enrichment programs offered by enrichment providers. For example, tens of thousands of enrichment providers across the United States offer a wide variety of education enrichment programs including drama, art, chess, ballet, music, mathematics, writing, computer programming, three-dimensional modeling and printing, public speaking, and wilderness adventures, just to name a few.

Enrichment providers offer their enrichment programs using a variety of different media. People may spend hours and days searching and planning extracurricular enrichment programs for themselves and their children. For example, each enrichment provider may have a website that allows people to research the various enrichment programs offered by the enrichment provider and register for selected programs. As a result, people have to separately research each enrichment provider's website in order to identify appropriate programs based on age, subject area, interest, and location. Parents also have to manually resolve scheduling conflicts between different program schedules for one or more children. For example, a parent planning summer camp schedules for one or more children has to sift through many different summer camps offered by multiple enrichment providers to create each child's program schedule while avoiding scheduling conflicts across different enrichment providers and across all the children of the parent, minimizing travel time, complying with age requirements, and keeping in mind each child's interest. When a program schedule has been determined, parents have to separately register each child with each enrichment provider by creating separate accounts and passwords and filling out each enrichment provider's registration form.

### DESCRIPTION OF THE DRAWINGS

FIG. 1 shows an Internet connected computer system with a data-storage device.

FIG. 2 shows a general architectural diagram for various types of a computer systems.

FIGS. 3A-3B show examples of camp and class activities, respectively, offered by two enrichment providers.

FIG. 4 shows an example graphical user interface that enables a user to input user attributes and initiate a search for predicted activities offered by enrichment providers.

FIG. 5 shows an example of user records of previously purchased activities and previously viewed activities recorded over time.

FIG. 6 shows an example map with a point that represents a location entered by a user and maximum driving distance.

FIG. 7 shows an expanded view of the parametric representation of the scoring function

FIGS. 8A-8B show examples of a user-feature vector and features of an activity-feature vector.

FIG. 9 shows examples of tables that represent activity preferences for users.

FIG. 10 shows two example predicted schedules displayed in a graphical user interface for two users.

FIG. 11 shows a control-flow diagram of a method to schedule activities offered by multiple enrichment providers.

FIG. 12 shows a control-flow diagram of the routine “encode user-attribute and activity-attribute vectors” called in FIG. 11.

FIG. 13 shows a control-flow diagram of the routine “minimize loss function £(Θ)” called in FIG. 11.

FIG. 14 shows a control-flow diagram of the routine “generate final schedule from predicted schedule in GUI” called in FIG. 11.

### DETAILED DESCRIPTION

This disclosure is directed to fully automated schedule recommendation methods and systems that generate one or more predicted schedules of activities, such as events, classes, courses, camps, workshops, private lessons, tutoring sessions, or any organized activities, lessons or schedules items, based on multiple user constraints, such as date ranges, age of user, interest, location of the user and locations of the enrichment providers. The schedule recommendation methods and systems allow enrichment providers a place to market and offer activities to users in a graphical user interface. A user is presented with a graphical user interface that enables the user to enter user information and constraints. When the user is finished entering the user information and constraints, the fully automated schedule recommendation methods and systems uses machine learning techniques to computationally predict activities that satisfy the user constraints and aggregates predicted schedules over time to propose full schedules of predicted activities that are most appropriate for the user and satisfies the multiple user constraints. The schedule recommendation methods and systems generate one or more schedules of predicted activities that are displayed in a graphical user interface. The schedule recommendation methods and systems enable the user to select individual predicted activities, register the user with the enrichment providers that offer the selected activities, and pay the enrichment providers for the selected activities when the user checks out. Unlike standard methods and systems for recommending schedules of activities, scheduler recommendation methods and systems described herein train scoring functions that are, in turn, computed from user feedback on full schedules, rather than individual user-activity pairs.

In the following description, various embodiments will be illustrated by way of example and not by way of limitation in the figures. References to various embodiments in this disclosure are not necessarily to the same embodiment. While specific implementations and other details are discussed, it is to be understood that this is done for illustrative purposes only. Examples of activities discussed below are with reference to camps and classes. But the schedule recommendation systems and methods can be used to schedule any type of activity.

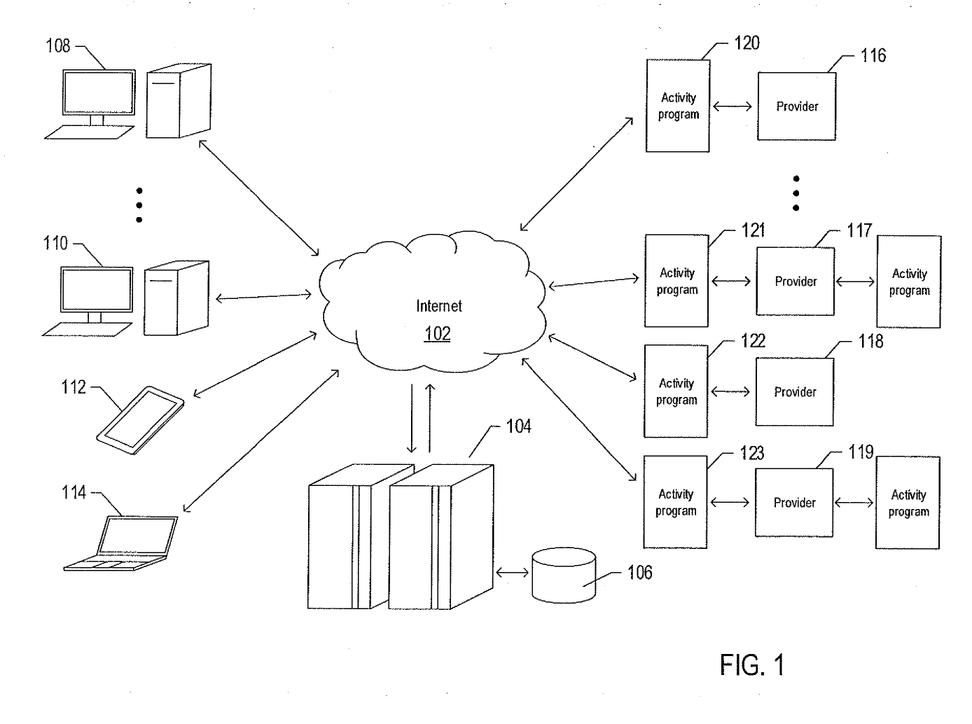

FIG. 1 shows an Internet 102 connected computer system 104 with a data-storage device 106. The computer system 104 and data-storage device 106 is a schedule recommendation system that stores and executes schedule recommendation methods implemented as a computer application called an “activity scheduler” that enables numerous users operating personal computers (“PCs”), mobile devices, and lap tops to schedule activities offered by numerous different providers of enrichment programs. As shown in FIG. 1, users interact with graphical user interfaces (“GUIs”) of the activity scheduler by way of the Internet 102 using PCs 108 and 110, a mobile device 112, and a lap top 114. The GUIs of the activity scheduler run in web browsers of the PCs 108 and 110, mobile device 112, and lap top 114. The computer system 104 stores, processes, and delivers web pages created by the activity scheduler in response to user interactions with the GUIs. Alternatively, mobile applications stored and executed on mobile devices, such as the mobile device 112, create GUIs that enable users to interact with the activity scheduler that runs in the computer system 104 to schedule activities offered by numerous different enrichment providers.

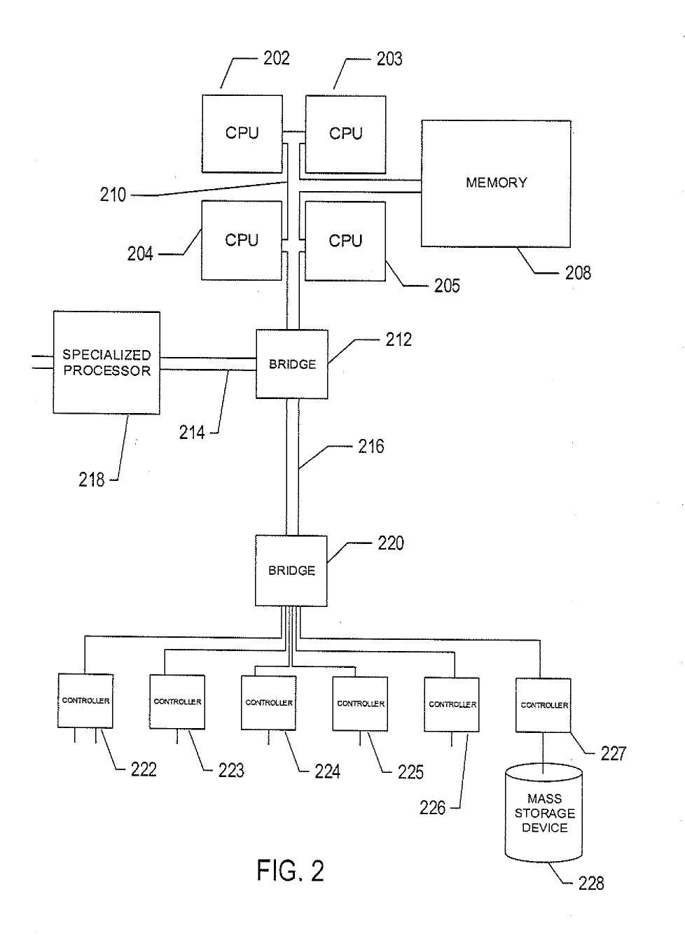

FIG. 2 shows a general architectural diagram for various types of a computer systems. Computer system 104 that runs the computer application may be described with reference to the general architectural diagram shown in FIG. 2, for example. The computer system contains one or multiple central processing units (“CPUs”) 202-205, one or more electronic memories 208 interconnected with the CPUs by a CPU/memory-subsystem bus 210 or multiple busses, a first bridge 212 that interconnects the CPU/memory-subsystem bus 210 with additional busses 214 and 216, or other types of high-speed interconnection media, including multiple, high-speed serial interconnects. These busses or serial interconnections, in turn, connect the CPUs and memory with specialized processors, such as a graphics processor 218, and with one or more additional bridges 220, which are interconnected with high-speed serial links or with multiple controllers 222-227, such as controller 227, that provide access to different types of mass-storage devices 228, electronic displays, input devices, and other such components, subcomponents, and computational devices. It should be noted that computer-readable data-storage devices include optical and electromagnetic disks, electronic memories, and other physical data-storage devices. The computer application may be stored as machine-readable instructions in the computer-readable media (i.e., the data-storage devices) and executed using one or more of the CPUs 202-205

Returning to FIG. 1, enrichment providers 116-119 may upload activity programs 120-123 to the computer system 104 using the Internet 102. Each activity program provides descriptions of the activities, dates, times, prices, and seat limits for each activity offered by the enrichment provider. The descriptions, dates, times, prices, and seat limits of the activity programs uploaded are organized into addressable, formatted data stored in the data-storage device 106 and is searched based on user criteria described below. Certain enrichment providers that upload activity schedules to the computer system 104, such as enrichment providers 117 and 119, may also maintain a separate activity program hosted by the enrichment provider that enables users to register for and enroll in activities directly with the enrichment providers via the enrichment provider's own web site or other means.

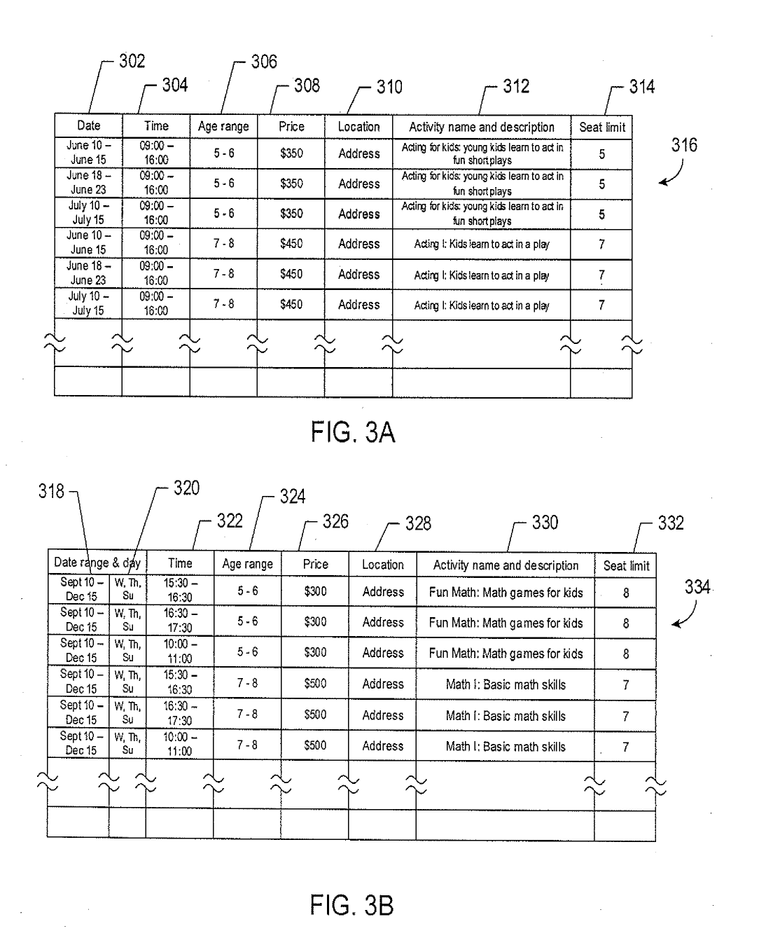

FIG. 3A shows an example of an activity program uploaded to the computer system 104 that list acting camps offered by an enrichment provider. The activity program is displayed in a table comprising columns that list date ranges 302, days 304 and times 306, age ranges 308, price 310, activity location (e.g., address) 312, name and description of camps 314, and seat limit 316. For example, a first camp 318 listed in the activity program runs from June 10-15, from 09:00 to 16:00, Monday, Wednesday and Friday, has an age range for students of 5-6 years old, a price of $350, and a seat limit of 5 students.

FIG. 3B shows an example of an activity program that list after school math classes offered by an enrichment provider. The activity program is displayed in a table comprising columns that list date ranges 318 and days of the week 320 when the classes are offered. The table also comprises columns that list times 322, age ranges 324, price 326, activity location (e.g., address) 328, name and description of classes 330, and seat limit 332. For example, a first math class 334 listed in the activity program runs from September 10 to December 15 on Monday, Thursday, and Sunday of each week from 15:30 to 16:30, has an age range of 5-6 years old, a price of $300, and a seat limit of 8 students.

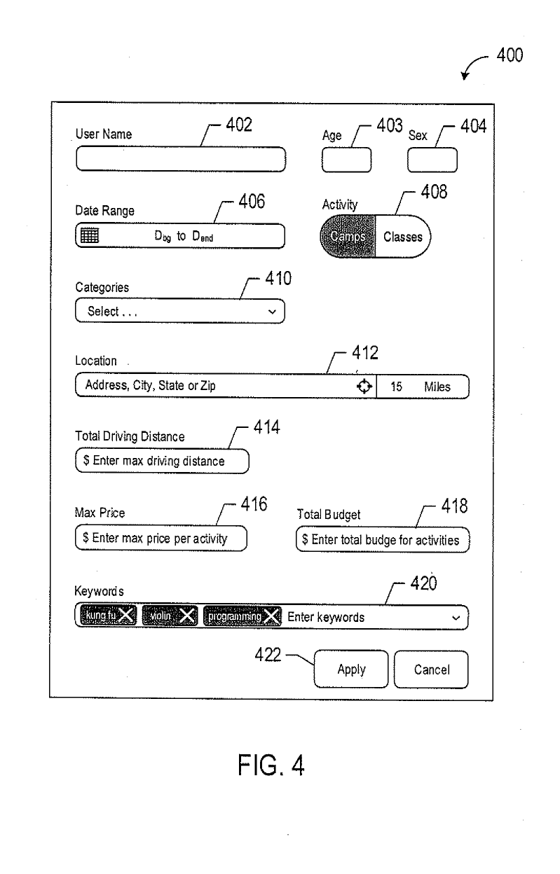

FIG. 4 shows an example graphical user interface (“GUI”) 400 that enables a user to input user attributes and initiate a search for predicted activities offered by enrichment providers. The GUI 400 may be displayed in a web page and includes text fields 402-404 to input a user name, age, and sex. The GUI 400 includes a text field 406 that is used to enter a date range where “D_{bg}” represents a begin date of the date range and “D_{end}” represents an end date of the date range. In the example of FIG. 4, the GUI 400 includes buttons 408 that enable the user to select two different types of activities, such as Camps and Classes. Text field 410 enables a user to enter a category of activities. Examples of categories include, but are not limited to, “dance,” “cooking,” “fitness,” “gymnastics,” “math,” “music,” “martial arts,” “science,” and “sports.” Text field 412 enables a user to enter a location, such as a specific address or zip code, and displays a default travel-distance limit of 15 miles from the location entered into the text field 410 or center of the area represented by the zip code. The location of the user input at text field 412 is denoted by loc(u), where u represents the user. Text field 414 enables the user to enter a maximum driving distance denoted by dₘₐₓ. Text field 416 enables the user to enter a maximum price the user is willing to pay for an activity denoted by pₘₐₓ. Text field 418 enables of the user to enter a total budget for activities denoted by bₜₒₜ. Text field 420 enables the user to enter one or more keywords associated with activities. Examples of keywords include, but are not limited to, “kung fu,” “violin,” and “programming.” The keywords enable a user to focus or refine a search for activities.

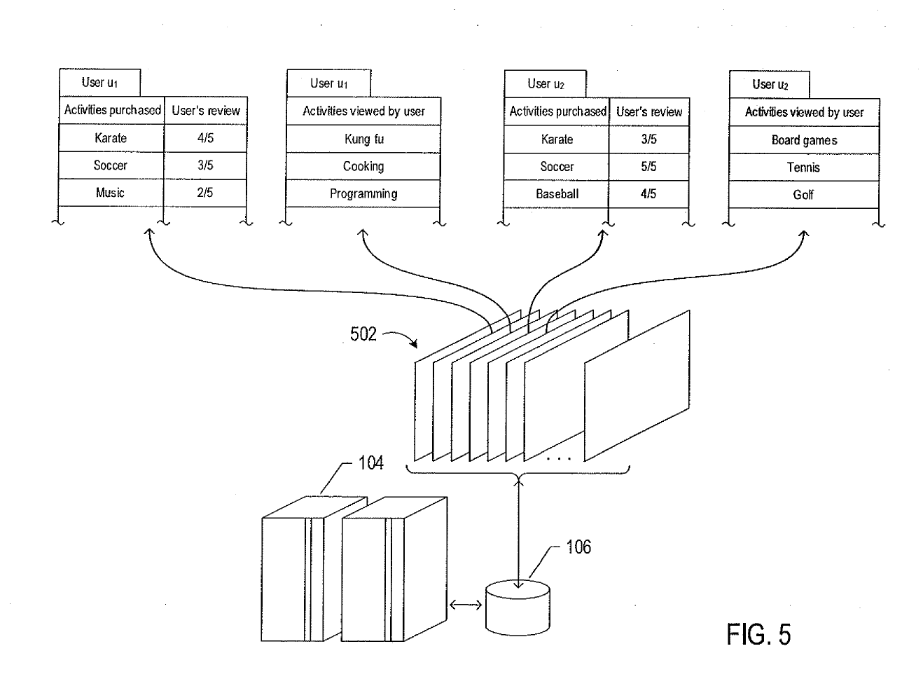

Whenever a user purchases an activity from an enrichment provider, the activity is marked as sold in the user's schedule. Records of the user's previously purchased activities, reviews of activities, and activities viewed by the user are recorded in user records. FIG. 5 shows an example of user records 502 of previously purchased activities and previously viewed activities recorded over time. The records 502 are stored in the data-storage device 106. In the example of FIG. 5, partial records of previously purchases activities and previously viewed activities of two users identified as user u₁ and user u₂ are displayed. The user u₁ has previously purchased the activities “Karate,” Soccer,” and “Music” and provided reviews regarding the user's level of satisfaction with these activities. For example, the user u₁ gave the activity “Karate” a score of 4 out 5 stars and the activity “Soccer” a score of 3 out of 5 stars, which indicates that user u₁ prefers Karate to Soccer. The record of previously viewed activities implies the user's preference for previously viewed activities over activities that have not been viewed by the user.

Returning to FIG. 4, when the user clicks on the “Apply” button 422, the user's inputs to the text fields of the GUI 400 are stored and the activities scheduler generates predicted activities for the user to select from based on the user's inputs and the user's previously purchased activities, reviews of activities, and activities viewed by the user. The activities scheduler also determines the predicted activities based on purchased activities, reviews, and activities viewed by all users.

In the following discussion, users are denoted uᵢ for i=1,2, . . . , N, where N is the number of users of the activity scheduler. Activities offered by enrichment providers are denoted by aₖ for k=1,2, . . . M, where M is the number of activities. The activities scheduler computes a numerical scoring value denoted by R(uᵢ, aₖ) that serves as a metric that predicts the utility of an activity aₖ for a user uᵢ. In other words, the scoring value R(uᵢ, aₖ) is a prediction of the user's preference for the activity aₖ.

Methods described below compute the scoring values R(uᵢ, aₖ) for all users and activities. Given the scoring values R(uᵢ, aₖ) for all users and activities, the scoring values R(uᵢ, aₖ) for a single user used to compute a predicted schedule of activities for the user according to a model of predicted schedule of activities given by:

$$R ( {u}_{i} , z ) = {\sum }_{{a}_{k}}^{ } {z}_{{u}_{i} , {a}_{k}} R ( {u}_{i} , {a}_{k} ) \qquad ( 1 )$$

where
zᵤ_{ᵢ}_{, a}_{ₖ} is a binary indicator; and
z represents a schedule.
   The binary indicator is given by:

$${z}_{{u}_{i} , {a}_{k}} = \{ \begin{matrix}0 , & for {a}_{k} not assigned to {u}_{i} \\ 1 , & for {a}_{k} assigned to {u}_{i}\end{matrix} \qquad ( 2 )$$

The schedule z comprises the non-zero binary indicators that are computed as described below. The predicted schedule of activities R(uᵢ, z) is a schedule of activities the user's is expected to prefer.

The activity scheduler computes the scoring values R(uᵢ, aₖ) for all users and activities. Integer linear programming, or another optimization method, maximizes a complete schedule of activities R(uᵢ, z) according to Equation (1), for a single user subject to a set of constraints. Multiple dimensions of ranking, such as the user's interest, price, and driving distance, can be integrated as hard constraints or attributes in R(uᵢ, aₖ).

Constraints used to maximize a predicted schedule of activities include time slots in which each activity is offered, maximum travel distance, maximum price per activity, novelty, and total budget for activities. Let time (aₖ) represent a time slot in which the activity aₖ is offered. A valid schedule of activities for Q desired time slots denoted by t₁, t₂, . . . , t_{Q} for a user uᵢ may have at most one activity assigned for each time slot. Note that activities may be predicted for all desired time slots, but it may be the case that no activities satisfy a user's constraints for the desired time slots. The set of such valid schedules may be described as the set of assignments to all binary indicators zᵤ_{ᵢ}_{,a}_{ₖ} that satisfy the following linear time constraint:

$${\sum }_{k : time ( {a}_{k} ) = t}^{ } {z}_{{u}_{i} , {a}_{k}} \leq 1 \qquad ( 3 )$$

for each t∈{t₁, t₂, . . . , t_{Q}}.

In other words, the time constraint introduces one constraint for each time slot t, where t ranges over the desired time slots for a given desired schedule (e.g. the time slot can be weeks in the summer). For example, consider a desired time slot, t=[Jun. 22, 2018 to Jun. 26, 2018]. The constraint of Equation (3) limits one activity aₖ assignment to the user for the desired time slot (i.e., time (aₖ)=t). Because each binary indicator is either 1 or 0, the less than or equal to 1 constraint is satisfied when one or fewer activities with time t are assigned.

Hard constraints, such as maximum travel distance, maximum price per activity, novelty, and total budget for activities, may be used to filter activities violating these constraints. For example, activities that are located within the maximum travel-distance limit are determined based on the location entered in the text field 410 and the addresses of the activity. Let dist(loc(uᵢ), loc(aₖ)) denote the driving distance between the location of the user and the location of the activity. For each activity, the maximum driving distance constraint is given by:

zᵤ_{ᵢ}_{,a}_{ₖ}dist(loc(uᵢ),loc(aₖ))≤dₘₐₓ (4)

The maximum driving distance constraint ensures that only sessions within the maximum travel distance are suggested.

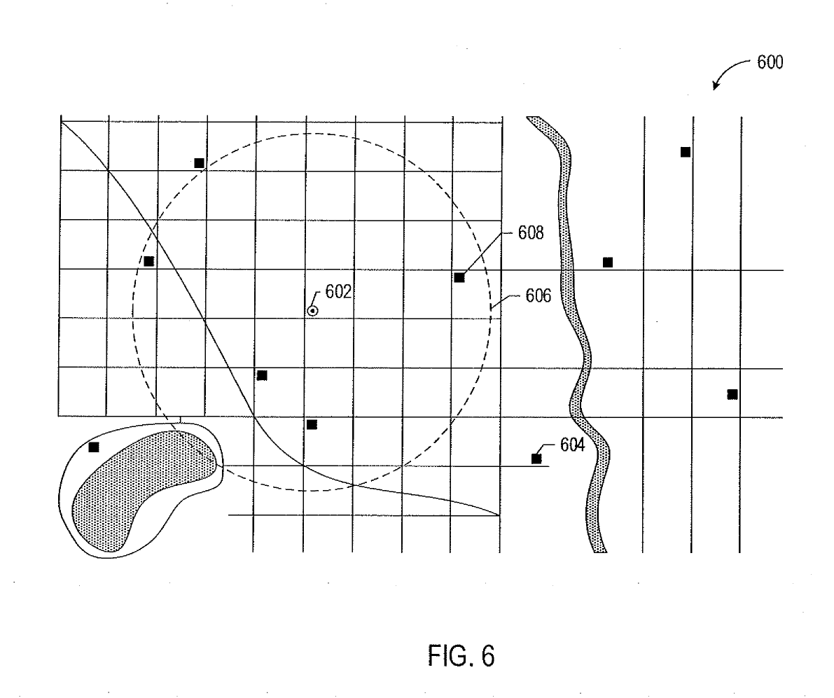

FIG. 6 shows an example map 600 with a point 602 that represents a location entered by a user. Shaded squares, such as shaded square 604, represent the locations of activities offered by enrichment providers. Dashed circle 606 has a radius equal to a maximum travel distance centered at the user entered location 602. Activities, such as activity 608, located within the circle 606 are identified as candidate activities. On the other hand, activities located outside the circle 606 (i.e., travel distance that exceed the maximum travel distance), such as the activity 604, are excluded.

The constraint for maximum price the user is willing to pay per activity is given by

zᵤ_{ᵢ}_{,a}_{ₖ}price(aₖ)≤pₘₐₓ (5)

where price (aₖ) is the price of the activity aₖ.

A hard constraint on the total budget for activities is given by:

$${\sum }_{{a}_{k}}^{ } {z}_{{u}_{i} , {a}_{k}} price ( {a}_{k} ) \leq {b}_{tot} \qquad ( 6 )$$

A novelty constraint limits consideration of activities to activities that have not already been purchased by the user. Let taken(uᵢ, aₖ) be an indication that the user uᵢ has already purchased the activity aₖ. The taken indicator taken(uᵢ, aₖ) can be determined from the database of previously purchased activities by user described above with reference to FIG. 5. The taken indicator is represented by:

$$taken ( {u}_{i} , {a}_{k} ) = \{ \begin{matrix}0 , & for {u}_{i} has not taken {a}_{k} \\ 1 , & for {u}_{i} has taken {a}_{k}\end{matrix} \qquad ( 7 )$$

The novelty constraint is given by

zᵤ_{ᵢ}_{,a}_{ₖ} taken(uᵢ,aₖ)≤0 (8)

In one implementation, a scoring value R(uᵢ, aₖ) may be learned for the scheduling problem using recommender system methods learned from transactions over complete schedules for users and update the associated parameters of all included activities. This allows the activity scheduler to learn a scoring value that is accurate when the scoring value is used to propose schedules of activities, under the assumption of additive preferences over an activity sequence as in Equation (2). This is also a stepping stone toward learning more global scores that includes multiple sessions in a schedule (e.g., ensuring diversity of classes across time) for a single user, or assignments to groups of users (e.g., minimizing driving distance across users).

The scoring values R(uᵢ, aₖ) are parameterized for each user-activation pair (uᵢ, aₖ) using a parametric model, ƒ(uᵢ, aₖ|Θ), called a “scoring function,” that are parameterized as follows:

ƒ(uᵢ,aₖ|Θ)=λ_{ƒ}Φ(uᵢ)^{T}WΦ(aₖ)+λᵥvᵤ_{ᵢ}^{T}vₐ_{ₖ} (9)

where
Φ(uᵢ) is user-attribute vector that represents attributes of the user
Φ(aₖ) is activity-attribute vector that represents attributes of the activity aₖ;
λ_{ƒ} is an interpolation weight for the attribute vectors;
W is a square weight matrix with elements that weight relationships between user-attribute vector elements to activity-attribute-vector elements;
vᵤ_{ᵢ} is a user-embedding vector that encodes collaborative filtering information from a history of past preferences of similar users to the user;
vₐ_{ₖ} is an activity-embedding vector that encodes collaborative filtering information from a history of past preferences of similar activities; and
λᵥ is an interpolation weight for the embedding vectors.

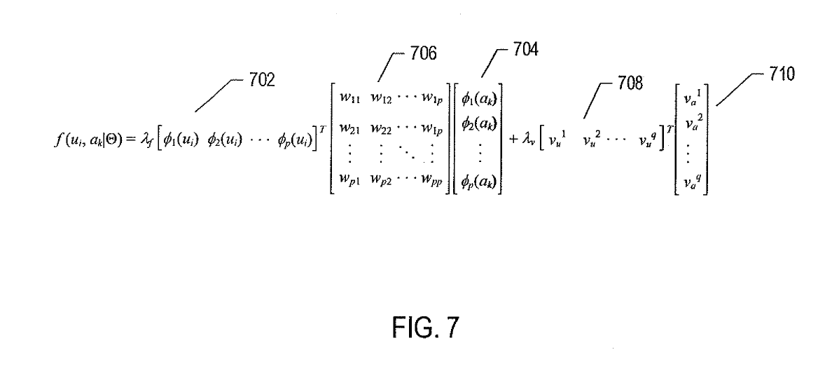

FIG. 7 shows an expanded view of the parametric representation of the scoring function of Equation (9). The user-attribute vector Φ(uᵢ) 702 comprises p elements that represent attributes of the user uᵢ. The activity-attribute vector Φ(aₖ) 704 comprises p elements that represent attributes of the activity aₖ. The weight matrix W 706 is represented as a square p×p matrix of weights that weigh connections between attributes of the user-attribute vector Φ(uᵢ) 702 and attributes of the activity-attribute vector Φ(aₖ) 704. The user-attribute vector Φ(uᵢ) 702 is formed from the user information input via the GUI 400 and the activity-attribute vector Φ(aₖ) 704 is formed from information about the activity provided by the enrichment provider.

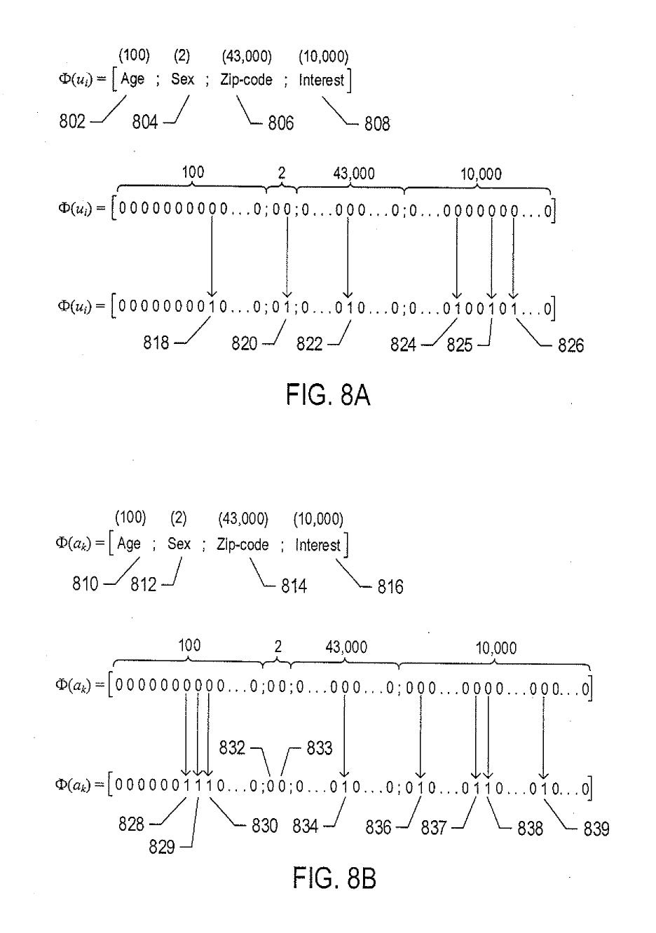

FIGS. 8A-8B show examples of a user-attribute vector Φ(uᵢ) and attributes of an activity-attribute vector Φ(aₖ). The user-attribute vector Φ(uᵢ) is a binary encoding of the input information provided by the user with GUI 400. The activity-attribute vector Φ(aₖ) is a binary encoding of information about the activity provided by the enrichment provider. One hundred binary digits are used to encode the age of the user or age range of an activity which is assumed to range from 1 to 100 years. Two binary digits are used to encode the sex of the user which is either male or female. Forty-three thousand binary digits are used to encode zip codes because there are approximately 43,000 zip codes in the United States. Ten thousand binary digits are used to encode ten thousand keywords or categories.

In the example of FIG. 8A, the user-attribute vector Φ(uᵢ) comprises a binary sequence 802 of 100 binary digits to encode the age of the user, a binary sequence 804 of 2 binary digits to encode the sex of the user, a binary sequence 806 of 43,000 binary digits to encode the zip code of the user, and a binary sequence 808 of 10,000 digits to encode the interests of the user. In the example of FIG. 8B, the activity-attribute vector Φ(aₖ) comprises a binary sequence 810 of 100 binary digits to encode the age range of the activity, a binary sequence 812 of 2 binary digits to encode a preferred sex, if any, of the user to engage in the activity, and a binary sequence 814 of 43,000 binary digits to encode the zip code of the location of the activity, and a binary sequence 816 of 10,000 digits that are used to encode the interests of associated with the activity as identified by the enrichment provider.

The user-attribute vector Φ(uᵢ) is initialized by assigning all binary digits the value 0. The age, gender, zip code, and interest of the user uᵢ are encoded by changing digits in each corresponding sequence to the value 1. For example, with reference to FIG. 8A, suppose the user uᵢ is a 9-year-old male living within the zip code 98105, and the user's interests identified using the categories and keywords of the GUI 400 are soccer, baseball, and tennis. The user's age is encoded in the age binary sequence 802 by changing the ninth binary digit 818 to 1. The user's sex is encoded in the sex binary sequence 804 by changing the binary digit 820 that corresponds to male to 1. The user's zip code is encoded in the zip-code binary sequence 806 by changing the binary digit 822 that corresponds to the zip code 98105 to 1. The user's interests are encoded in the interest binary sequence 808 by changing the binary digits 824-825 that corresponds to keywords soccer, baseball, and tennis to 1.

The activity-attribute vector Φ(aₖ) is initialized by also assigning all binary digits the value 0. The age range, gender, zip code, and interests identified by the enrichment provider of the activity aₖ are also encoded by changing digits in each corresponding sequence to the value 1. For example, with reference to FIG. 8B, suppose the age range for users to participate in the activity aₖ is 7-9 years of age. Users are not required to be of a particular sex to participate in the activity. The location of the activity is in the zip code 98103, and the interests identified by the enrichment provider are fitness, outdoors, summer sports, and golf. The age range is encoded in the age binary sequence 810 by changing the seventh, eighth, and ninth binary digits 828-830 to 1. Because the user's sex is not relevant, the female and male binary digits 832 and 833 in the sex binary sequence 812 are left unchanged. The enrichment provider's zip code is encoded in the zip-code binary sequence 814 by changing the binary digit 834 that corresponds to the zip code 98103 to 1. The interest identified by the enrichment provider are encoded in the interest binary sequence 816 by changing the binary digits 836-839 that corresponds to keywords fitness, outdoors, summer sports, and golf to 1.

Returning to FIG. 7, the parameters Θ in parametric Equation (9) represents the unknown parameters in the weight matrix W 702, interpolation weights λ_{ƒ} and λᵥ, and embedding vectors vᵤ_{ᵢ} 708 and vₐ_{ₖ} 710. Activity scheduler trains the scoring functions to obtain the parameters Θ based on user attributes and preferences over user-activity pairs (uᵢ, aₖ) by minimizing a loss function of the scoring functions and the parameters Θ given by:

$$ℒ ( Θ ) = - {\sum }_{l = 1}^{L} log [ \frac{{e}^{f} ( {u}^{l} , {a}^{l} \vert Θ )}{{e}^{f} ( {u}^{l} , {a}^{l} \vert Θ ) + {e}^{f} ( {u}^{l} , {b}^{l} \vert Θ )} ] + {λΘ}^{T} Θ \qquad ( 10 )$$

where the last term on the right-hand side of Equation (10) regularizes of the parameters Θ. Given an observation that a user uᵢ prefers activity aₖ to activity bⱼ, minimization of the loss function in Equation (10) maximizes the difference between the scoring functions ƒ(u^{l}, a^{l}|Θ)−ƒ(u^{l}, bₗ|Θ). The summation in Equation (10) is over (u^{l}, a^{l}, b^{l}) for which the user u^{l} prefers activity a^{l} to activity b^{l}. The summation limit L denotes the number preferences where activity a^{l} is preferred to activity b^{l}. User preferences can be determined from user reviews of previously purchased activities or implied from user views (e.g., clicks on activities) displayed on the activity scheduler web page, as described above with reference to FIG. 5, or implied when a user manually rejects a suggested activity by replacing the suggested activity in the user's schedule with a different activity in the user's schedule.

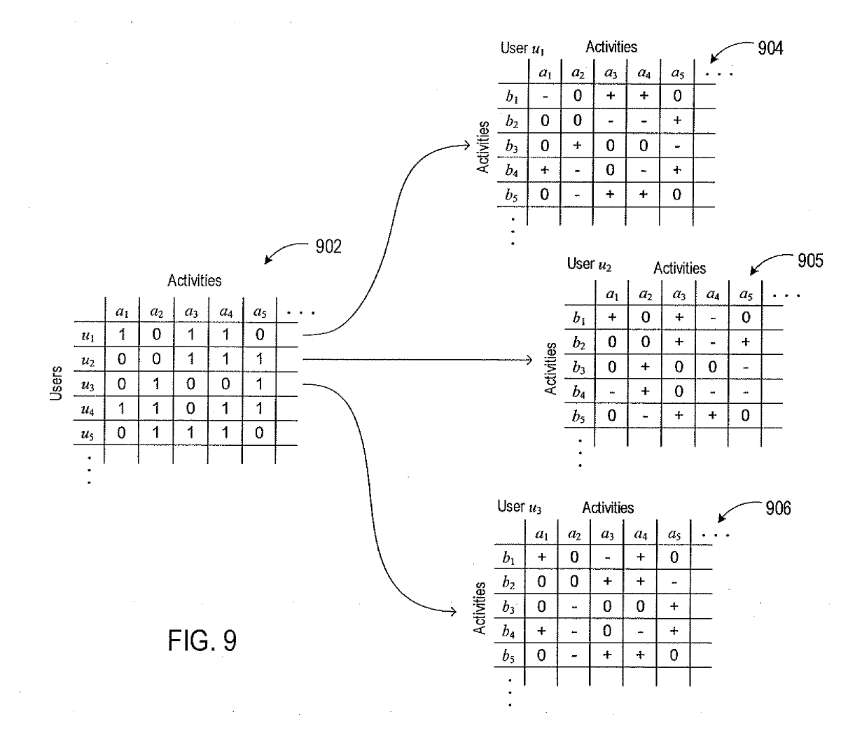

FIG. 9 shows a table 902 of activity preferences for users. Table entries with the number 1 represent activities where the user has previously purchased the activity or has viewed the activity, such as by clicking on the activity in the web page. Table entries with the number 0 represent activities for which no preference is known. In other words, the user has not purchased the activity nor has the user viewed the activity. For example, user u₁ purchased or viewed activities a₁, a₃ and a₄, but the user u₁ has not purchased nor viewed activities a₂ and a₅. FIG. 9 also includes tables 904-906 that represent preferences for all activities by users u₁, u₂, and u₃, respectively. In tables 904-906, entries with the number 0 correspond to pairs of activities for which no preference of one activity over another is known. Entries with the symbol “+” represent cases where the user preferred the activity a over activity b. Entries with the symbol “−” represent cases where the user preferred the activity b over the activity a. The summation in Equation (10) is over known user preferences where activity a is preferred over activity b. For example, suppose there are only the users u₁, u₂, and u₃. The summation in Equation (10) would be over the known user preferences represented by the symbol “+” and excludes entries with “−” and entries with the number 0.

The loss function of Equation (10) may be minimized using a standard stochastic gradient descent method represented by

$${Θ}_{i + 1} = {Θ}_{i} + α \frac{\partial ℒ ( {Θ}_{i} )}{\partial Θ} \qquad ( 11 )$$

where

$$\frac{\partial ℒ ( Θ )}{\partial Θ}$$

is me gradient of the loss function with respect to the parameters Θ; and
α is a learning rate.
   The parameters Θ and learning rate are initialized and the operation of Equation (11) is repeated until ∥Θᵢ₊₁−Θᵢ∥<ε (i.e., convergence), where ε is a small number greater than zero, or is repeated for a fixed number of iterations.

Computation of the scoring functions in Equation based on the loss function is performed periodically for all user-activation pairs (uᵢ, aₖ) managed by the activity scheduler. Minimization of the loss function using stochastic gradient descent in Equation (11) gives a set of scoring functions for all user-activation pairs (uᵢ, aₖ):

{ƒ(uᵢ,aₖ|Θ)i=1, . . . ,N;k==1, . . . M} (12a)

The set of scoring functions are sorted to select the scoring functions associated with a particular user uᵢ:

{ƒ(uᵢ,aₖ|Θ)|k=1, . . . M} (12b)

The scoring values for the user uᵢ are assigned the corresponding scoring functions as follows:

R(uᵢ,aₖ)=ƒ(uᵢ,aₖ|Θ) (13)

for each activity k=1, . . . M.

Given the scoring values R(uᵢ, aₖ) for a user uᵢ, and a set of constraints over full schedules, a constrained optimization problem is formulated as represented in Equation (1). The scoring values R(uᵢ, aₖ) are substituted into Equation (1), which is maximized using Integer Linear Programming, or another optimization method, subject to the constraints in Equations (3)-(8) to obtain a set of non-zero binary indicators described above with reference to Equation (2):

Z={zᵤ_{ᵢ}_{,a}_{ₖ}} (14)

where zᵤ_{ᵢ}_{,a}_{ₖ}=1 for certain activities aₖ. A complete schedule for the user uᵢ is formed based on the non-zero binary indicators in the set z. An activity aₖ is added to the predicted schedule, when zᵤ_{ᵢ}_{,a}_{ₖ}=1. Otherwise, the activity aₖ is not added to the predicted schedule, when zᵤ_{ᵢ}_{,a}_{ₖ}=0.

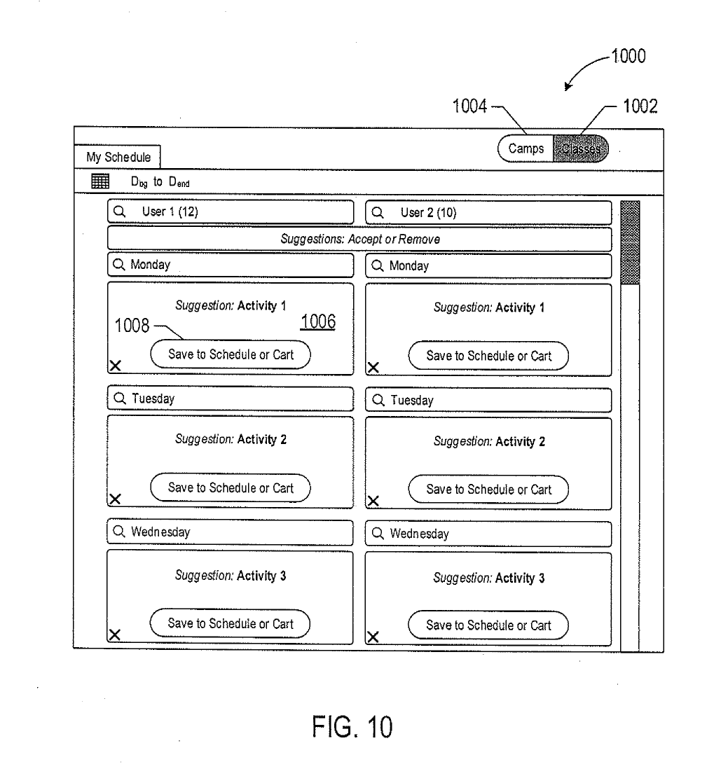

FIG. 10 shows two example predicted schedules displayed in a GUI 1000 for two users u₁ and u₂. Each activity displayed in the GUI 1000 corresponds to a scoring value and an associated non-zero binary indicator. In the example of FIG. 10, classes button 1002 is highlighted, which displays only the activities that are classes. Clicking the camps button 1004 would change the GUI 1000 to display only the activities that are camps. For example, activity “Activity 1” 1006 represents a class under user u₁ and corresponds to the scoring value R(u₁, Activity 1) and non-zero binary indicator zᵤ_{₁}_{,Activity 1}=1. When the user clicks on a “Save to Schedule or Cart” button, such as button 1008, the activity is added to the user's complete schedule. When the user checks out after have selected predicted activities for a schedule, the enrichment providers are paid, and the number of available seats for the activity is decremented and registration with the enrichment providers is completed.

Activity scheduler includes learning from preferences over proposed schedules. Since methods and systems determine predicted schedules for the user, a loss function may be defined over the predicted schedules. Let z₁ and z₂ represent two predicted schedules of activities that both satisfy a set of constraints (e.g. complete schedules that satisfy the constraints represented by Equations (3)-(8)). For example, z₁ comprises the non-zero binary indicators of a first predicted schedule and z₂ comprises the non-zero binary indicators of a second predicted schedule. As described above with reference to FIG. 9, explicit or implicit user feedback that a user u prefers predicted schedule z₁ to predicted schedule z₂, the methods score the first predicted schedule higher than the second predicted schedule. A similar loss function to the loss function in Equation (10) is given by

$$ℒ ( Θ ) = - {\sum }_{l = 1}^{L} log [ \frac{{e}^{f} ( {u}^{l} , {z}_{1}^{l} \vert Θ )}{{e}^{f} ( {u}^{l} , {z}_{1}^{l} \vert Θ ) + {e}^{f} ( {u}^{l} , {z}_{2}^{l} \vert Θ )} ] + {λΘ}^{T} Θ \qquad ( 15 )$$

The loss function of Equation (15) depends on preferences over predicted schedules in the same manner the loss function of Equation (10) depends on preferences of activities. In the basic case, the scoring value of a predicted schedule is the sum of scoring values of the individual assigned activities in Equation (1). The scoring functions obtained from minimizing Equation (15) as described above with reference to Equation (11) are used to determine a preference for a predicted schedule.

In order to obtain user preferences over predicted schedules, methods and systems record users' booked schedules in the past and sample alternative predicted schedules which may be valid with respect to the constraints, and assume that random predicted schedules are less preferred. When methods are able to use a first iteration of the activity scheduler to propose full schedules to a user, the activity scheduler learns from whether a user decides to adjust an initially predicted schedule, in which case the final schedule the user selects is assumed to be preferred over the other predicted schedule.

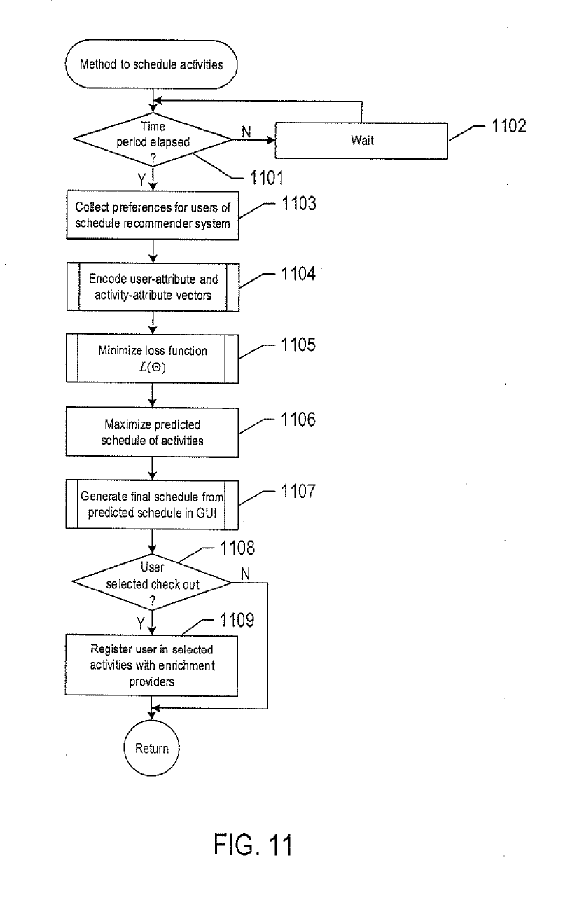

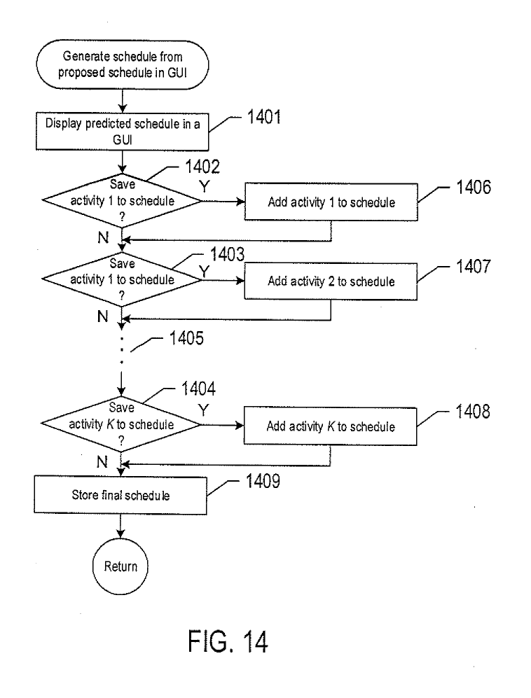

FIG. 11 shows a control-flow diagram of a computational method to schedule activities offered by multiple enrichment providers. The method comprises computer implemented modules, or routines, each comprising a series of machine-readable instructions stored in one or more data-storage devices and executed using one or more processors of a computer system described above with reference to FIG. 2. In decision block 1101, when a time period has elapsed control flows to block 1103. Otherwise control flows to block 1102 in which the time period is allowed to lapse. In block 1103, attributes and preferences associated with each user are read from the data-storage device, as described above with reference to FIG. 5. In block 1104, a routine “encode user-attribute and activity-attribute vectors” is called. In block 1105, a routine “minimize loss function [symbol] (Θ)” is called. In block 1106, scoring functions obtained as a result of minimizing the loss function in block 1105 are input to a model of predicted schedule of activities which is maximized using integer linear programming subject to user constraints input via the GUI 400. In block 1107, a routine “generate final schedule from predicted schedule in GUI” is called. In decision block 1108, when the user decides to check out, such as clicking on a “check out” button, control flows to block 1109. In block 1109, the user is enrolled in each of the activities selected in FIG. 14. For example, the user is registered in the activities of the final schedule by updating the corresponding enrichment provider's list of users over the Internet and completing payment by the user to the enrichment providers for the activities selected by the user.

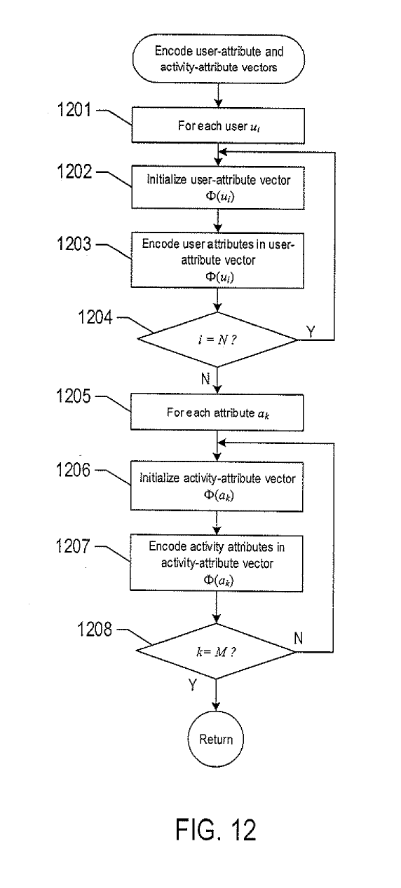

FIG. 12 shows a control-flow diagram of the routine “encode user-attribute and activity-attribute vectors” called in block 1104 of FIG. 11. A loop beginning with block 1201 repeats the computational operations represented by blocks 1202-1203 for each user. In block 1202, a user-attribute vector is initialized to zero for each binary digit of the user-attribute vector as described above with reference to FIG. 8A. In block 1203, attributes of the user input to the GUI 400 are encoded in corresponding binary digits of the user-attribute vector as described above with reference to FIG. 8A. In decision block 1204, when user index i equals the number of users N, control flows to block 1205. A loop beginning with block 1205 repeats the computational operations represented by blocks 1206-1207 for each activity. In block 1206, an activity-attribute vector is initialized to zero for each binary digit of the activity-attribute vector as described above with reference to FIG. 8B. In block 1207, attributes of the activity provided by the enrichment provider are encoded in corresponding binary digits of the activity-attribute vector as described above with reference to FIG. 8B. In decision block 1204, when activity index k equals the number of attributes M, the user-attribute and activity-attribute vectors are returned.

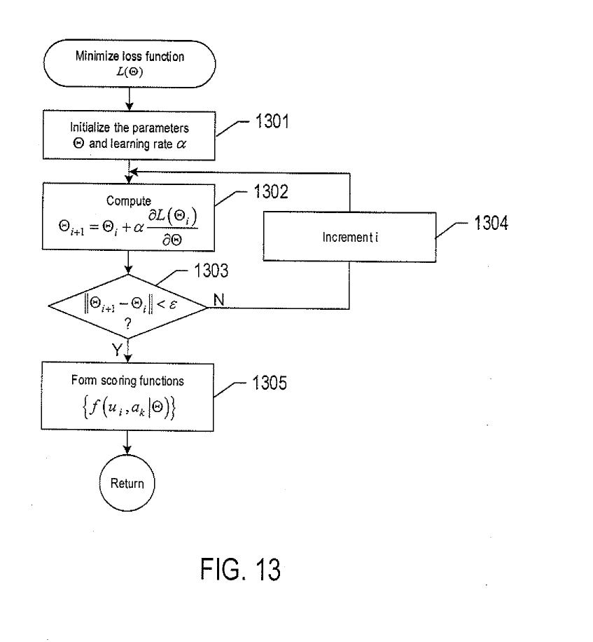

FIG. 13 shows a control-flow diagram of the routine “minimize loss function [symbol] (Θ)” called in block 1105 of FIG. 11. In block 1301, the parameters Θ and the learning rate α are initialized. In block 1302, the parameters Θᵢ are updated based on the gradient of the loss function and learning rate as described above with reference to Equation (11). In decision block 1303, when the parameters have converged, control flows to block 1305. Otherwise, control flows to block 1304 and the parameters Θᵢ are updated in block 1302 for another iteration. In block 1305, scoring functions are formulated from the converged parameters Θ as described above with reference to Equation (12).

FIG. 14 shows a control-flow diagram of the routine “generate final schedule from predicted schedule in GUI” called in block 1107 of FIG. 11. In block 1401, the predicted schedule determined in block 1106 is displayed in a GUI as described above with reference to FIG. 10. The GUI provides a list of all the activities suggested by the activity scheduler and enables the user to individually accept each activity. In decision blocks 1402-1404, when a user selects any one or more of the activities presented in the GUI of the predicted schedule, control flows to corresponding blocks 1406-1408 in which the selected activity is added to a final schedule of activities associate with the user. Ellipsis 1405 represents other activities the user may select but are not shown. In block 1409, the final schedule is recorded in the data-storage device.

It is appreciated that the description of the disclosed embodiments is provided to enable any person skilled in the art to make or use the present disclosure. Various modifications to these embodiments will be clear to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A computer implemented process to schedule multiple activities offered by multiple enrichment providers for multiple users, the process comprising:
recording in a data-storage device preferences for activities purchased by the users and activities viewed by the users in graphical user interfaces that display the activities and enables the users to purchase the activities from enrichment providers of the activities;
encoding attributes of each user in a corresponding user-attribute vector;
encoding attributes of each activity in a corresponding activity-attribute vector;
periodically training scoring functions based on user-attribute vectors, activity-attribute vectors, the preferences and activities viewed by the users, each scoring function is a numerical value representing a prediction of each user's preference for each activity;
maximizing a predicted schedule of activities for a user, based on the scoring functions and constraints entered by the user in a graphical user interface; and
when the user selects an activity in the predicted schedule of activities, registering the user with each enrichment provider of the activity selected by the user.

2. The process of claim 1 wherein the attributes of each user include age, sex, location, and interests of the user.

3. The process of claim 1 wherein the attributes of each activity include age range, sex, location of activity, and interests associated with the activity as supplied by the enrichment provider of the activities.

4. The process of claim 1 wherein encoding the attributes of each user comprises encoding each attribute of the user as a change in a corresponding binary digit of the user-attribute vector.

5. The process of claim 1 wherein encoding the attributes of each activity comprises encoding each attribute of the activity as a change in a corresponding binary digit of the activity-attribute vector.

6. The process of claim 1 wherein training scoring functions based on the user-attribute vectors and the activity-attribute vectors comprises:
initializing parameters of the scoring functions and a learning rate;
iteratively computing parameters that minimize a gradient of a loss function formulated from the parameters, user-attribute vectors, activity-attribute vectors, and the preferences and activities viewed by the users; and
computing the scoring function based on the parameters, user-attribute vectors, and activity-attribute vectors.

7. The process of claim 1 wherein maximizing the predicted schedule of activities comprises:
identifying scoring functions associated with the user;
maximizing a linear equation of the scoring functions associated with the user and binary indicators based on the user constraints, each non-zero binary indicator obtained from maximizing the linear equation corresponds to one of the activities; and
forming the predicted schedule from activities with corresponding non-zero binary indicators.

8. A system to schedule activities offered by multiple enrichment providers, the system comprising:
one or more processors;
one or more data-storage devices; and
machine-readable instructions stored in the one or more data-storage devices that when executed using the one or more processors controls the system to carry out
recording in a data-storage device preferences for activities purchased by the users and activities viewed by the users in graphical user interfaces that display the activities and enables the users to purchase the activities from enrichment providers of the activities;
encoding attributes of each user in a corresponding user-attribute vector;
encoding attributes of each activity in a corresponding activity-attribute vector;
periodically training scoring functions based on user-attribute vectors, activity-attribute vectors, the preferences and activities viewed by the users, each scoring function is a numerical value representing a prediction of each user's preference for each activity;
maximizing a predicted schedule of activities for a user, based on the scoring functions and constraints entered by the user in a graphical user interface; and
when the user selects an activity in the predicted schedule of activities, registering the user with each enrichment provider of the activity selected by the user.

9. The system of claim 7 wherein the attributes of each user include age, sex, location, and interests of the user.

10. The system of claim 7 wherein the attributes of each activity include age range, sex, location of activity, and interests associated with the activity as supplied by the enrichment provider of the activities.

11. The system of claim 7 wherein encoding the attributes of each user comprises encoding each attribute of the user as a change in a corresponding binary digit of the user-attribute vector.

12. The system of claim 7 wherein encoding the attributes of each activity comprises encoding each attribute of the activity as a change in a corresponding binary digit of the activity-attribute vector.

13. The system of claim 7 wherein training scoring functions based on the user-attribute vectors and the activity-attribute vectors comprises:
initializing parameters of the scoring functions and a learning rate;
iteratively computing parameters that minimize a gradient of a loss function formulated from the parameters, user-attribute vectors, activity-attribute vectors, and the preferences and activities viewed by the users; and
computing the scoring function based on the parameters, user-attribute vectors, and activity-attribute vectors.

14. The process of claim 1 wherein maximizing the predicted schedule of activities comprises:
identifying scoring functions associated with the user;
maximizing a linear equation of the scoring functions associated with the user and binary indicators based on the user constraints, each non-zero binary indicator obtained from maximizing the linear equation corresponds to one of the activities; and
forming the predicted schedule from activities with corresponding non-zero binary indicators.

15. A non-transitory computer-readable medium encoded with machine-readable instructions that implement a method carried out by one or more processors of a computer system to perform the operations of
recording in a data-storage device preferences for activities purchased by the users and activities viewed by the users in graphical user interfaces that display the activities and enables the users to purchase the activities from enrichment providers of the activities;
encoding attributes of each user in a corresponding user-attribute vector;
encoding attributes of each activity in a corresponding activity-attribute vector;
periodically training scoring functions based on user-attribute vectors, activity-attribute vectors, the preferences and activities viewed by the users, each scoring function is a numerical value representing a prediction of each user's preference for each activity;
maximizing a predicted schedule of activities for a user, based on the scoring functions and constraints entered by the user in a graphical user interface; and
when the user selects an activity in the predicted schedule of activities, registering the user with each enrichment provider of the activity selected by the user.

16. The medium of claim 15 wherein the attributes of each user include age, sex, location, and interests of the user and the attributes of each activity include age range, sex, location of activity, and interests associated with the activity as supplied by the enrichment provider of the activities.

17. The medium of claim 15 wherein encoding the attributes of each user comprises encoding each attribute of the user as a change in a corresponding binary digit of the user-attribute vector.

18. The medium of claim 15 wherein encoding the attributes of each activity comprises encoding each attribute of the activity as a change in a corresponding binary digit of the activity-attribute vector.

19. The medium of claim 15 wherein training scoring functions based on the user-attribute vectors and the activity-attribute vectors comprises:
initializing parameters of the scoring functions and a learning rate;
iteratively computing parameters that minimize a gradient of a loss function formulated from the parameters, user-attribute vectors, activity-attribute vectors, and the preferences and activities viewed by the users; and
computing the scoring function based on the parameters, user-attribute vectors, and activity-attribute vectors.

20. The medium of claim 15 wherein maximizing the predicted schedule of activities comprises:
identifying scoring functions associated with the user;
maximizing a linear equation of the scoring functions associated with the user and binary indicators based on the user constraints, each non-zero binary indicator obtained from maximizing the linear equation corresponds to one of the activities; and
forming the predicted schedule from activities with corresponding non-zero binary indicators.
